(19) United States
(12) Patent Application Publication
(10) Pub. No.: US 2023/0251608 A1
(43) Pub. Date: Aug. 10, 2023

(54) OPTIMAL CONTROL OF DYNAMIC SYSTEMS VIA LINEARIZABLE DEEP LEARNING

(71) Applicant: INTERNATIONAL BUSINESS MACHINES CORPORATION, Armonk, NY (US)

(72) Inventors: Dzung Tien Phan, Pleasantville, NY (US); Jayant R. Kalagnanam, Briarcliff Manor, NY (US); Lam Minh Nguyen, Ossining, NY (US)

(21) Appl. No.: 17/665,944

(22) Filed: Feb. 7, 2022

(51) Int. Cl. G05B 13/02; G05B 13/04

(52) U.S. Cl. CPC G05B 13/027; G05B 13/048

(57) ABSTRACT

A method includes: receiving, by a computing device, data from sensors in a manufacturing environment; mapping, by the computing device, the data into a deep learning network; learning, by the computing device, correlations between inputs and outputs of the manufacturing environment using the data; pruning, by the computing device, the deep learning network; predicting, by the computing device and using the pruned network, an output of the pruned network from the inputs of the manufacturing environment; linearizing, by the computing device, the pruned network; optimizing, by the computing device, the output of the linearized pruned network to calculate predicted inputs for the manufacturing environment; and changing, by the computing device, operation inputs in the manufacturing environment to match the predicted inputs.

### BACKGROUND

Aspects of the present invention relate generally to dynamic systems and, more particularly, to optimal control of dynamic systems via linearizable deep learning.

Production manufacturing processes include various parameters. Optimizing these parameters allows for optimization of the manufacturing process.

### SUMMARY

In a first aspect of the invention, there is a computer-implemented method including: receiving, by a computing device, data from sensors in a manufacturing environment; mapping, by the computing device, the data into a deep learning network; learning, by the computing device, correlations between inputs and outputs of the manufacturing environment using the data; pruning, by the computing device, the deep learning network; predicting, by the computing device and using the pruned network, an output of the pruned network from the inputs of the manufacturing environment; linearizing, by the computing device, the pruned network; optimizing, by the computing device, the output of the linearized pruned network to calculate predicted inputs for the manufacturing environment; and changing, by the computing device, operation inputs in the manufacturing environment to match the predicted inputs.

In another aspect of the invention, there is a computer program product including one or more computer readable storage media having program instructions collectively stored on the one or more computer readable storage media. The program instructions are executable to: receive data from sensors in a manufacturing environment; map the data into a deep learning network; learn correlations between inputs and outputs of the manufacturing environment using the data; prune the deep learning network; predict inputs for the manufacturing environment using the pruned deep learning network; linearize the pruned deep learning network; optimize a predicted output from the linearized pruned deep learning network to calculate predicted inputs for the manufacturing environment; and change operation inputs in the dynamic manufacturing environment to match the predicted inputs.

In another aspect of the invention, there is system including a processor, a computer readable memory, one or more computer readable storage media, and program instructions collectively stored on the one or more computer readable storage media. The program instructions are executable to: receive data from sensors in a dynamic manufacturing environment; map the data into a recurrent neural network (RNN) network; learn correlations between inputs and outputs of the dynamic manufacturing environment using the RNN network; prune the RNN network; predict inputs for the dynamic manufacturing environment using the pruned RNN network; linearize the pruned RNN network; optimize a predicted output from the linearized pruned RNN network to calculate predicted inputs; and change operation inputs in the dynamic manufacturing environment to match the predicted inputs.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows a block diagram of an exemplary environment in accordance with aspects of the invention.

FIG. 5 shows a flowchart of an exemplary method in accordance with aspects of the invention.

FIG. 6 shows an exemplary use in accordance with aspects of the invention.

### DETAILED DESCRIPTION

Aspects of the present invention relate generally to dynamic systems and, more particularly, to optimal control of dynamic systems via linearizable deep learning. According to aspects of the invention, sensors collect data from a dynamic manufacturing environment. In embodiments, a system inputs the data into deep learning networks to learn correlations between inputs, states, and outputs of the dynamic manufacturing environment. By learning the correlations between inputs, states, and outputs, the system is able to predict the inputs for a desirable output. In this manner, implementations of the invention allow for the optimization of a dynamic manufacturing environment by predicting inputs which result in a desirable output.

In embodiments, there is a computer-implemented method which includes optimizing predictions to satisfy optimal control manufacturing processes with dynamics capabilities for sequential decision making using deep learning techniques. In embodiments, optimizing the predictions includes ingesting data from sensors using supervisory control and data acquisition (SCADA) architecture, and data acquisition (DAQ) architecture, amongst other examples. In embodiments, optimizing the predictions also includes self-learning correlations between key process performance variables and state/control variables. In embodiments, the self-learning correlations include using a recurrent neural network (RNN) or a long-short term memory network (LSTM) with piece-wise linear activation functions such as rectified linear unit (ReLU) and piecewise linear unit (PLU) to learn the relationship between system states and actions with the output. In embodiments, the computer-implemented method includes pruning the deep neural networks using linear mappings with sparse and low rank matrices. In embodiments, the computer-implemented method includes reformulating the RNN and the LSTM into a mixed integer linear program representation.

Aspects of the invention provide an improvement in the field of manufacturing environments by providing a technical solution to the problem of dynamic manufacturing environments with changing states that result in sub-optimal production levels. In embodiments, the technical solution involves the steps of: a) receiving data from sensors in a manufacturing environment; b) mapping the data into a deep learning network; c) learning correlations between inputs and outputs of the manufacturing environment using the data; d) pruning the deep learning network; e) predicting using the pruned deep learning network an output of the pruned network from inputs for the manufacturing environment; f) changing operation inputs in the manufacturing environment to match the predicted inputs. In this way, a dynamic manufacturing environment performs at an optimal production level by using predicted inputs which optimize production.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium or media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

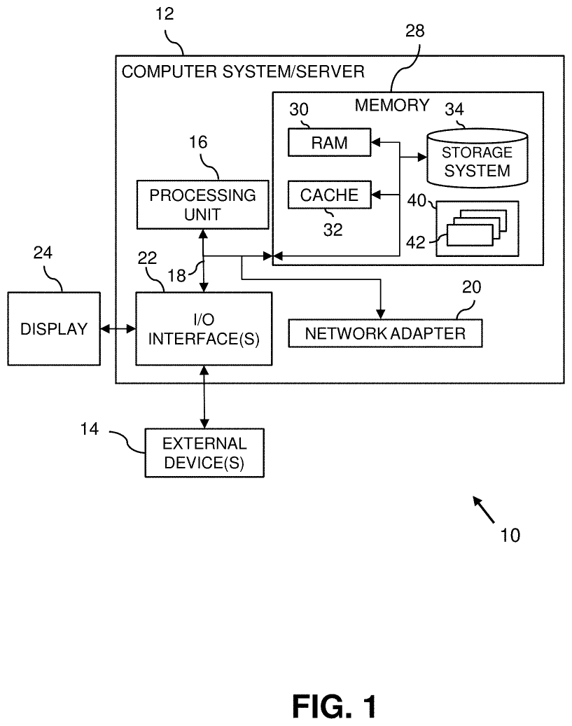

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

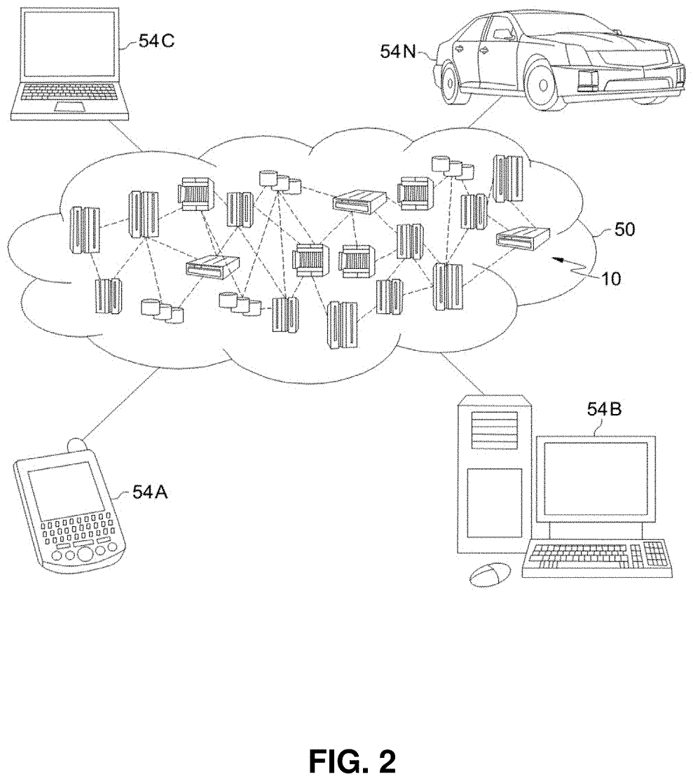

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

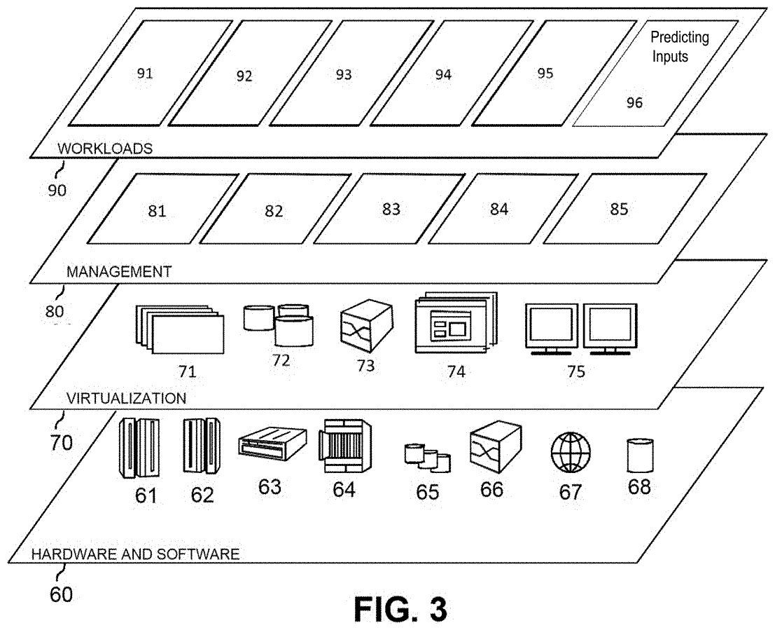

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and predicting inputs 96.

Implementations of the invention may include a computer system/server 12 of FIG. 1 in which one or more of the program modules 42 are configured to perform (or cause the computer system/server 12 to perform) one of more functions of the predicting inputs 96 of FIG. 3. For example, the one or more of the program modules 42 may be configured to: a) receive data from sensors in a manufacturing environment; b) map the data into a deep learning network; c) learn correlations between inputs and outputs of the manufacturing environment using the data; e) prune the deep learning network; f) predict using the pruned deep learning network an output of the pruned network from the inputs of the manufacturing environment; g) optimize the output of the pruned network to calculate predicted inputs for the manufacturing environment; and h) change operation inputs in the manufacturing environment to match the predicted inputs.

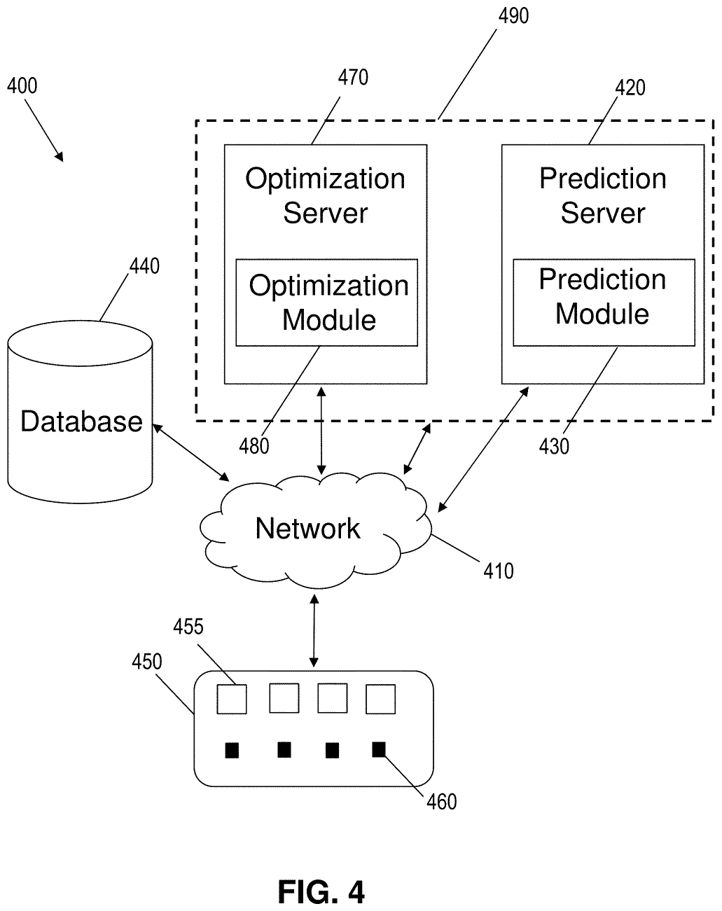

FIG. 4 shows a block diagram of an exemplary environment 400 in accordance with aspects of the invention. In embodiments, the environment 400 includes a network 410, a prediction server 420, a database 440, an optimization server 470, and a dynamic manufacturing environment 450.

The network 410 comprises one or more computer networks, such as one or more of a LAN, WAN, and the Internet. In one embodiment, the network 410 is representative of a cloud computing environment, such as described in FIG. 2.

In embodiments, the prediction server 420 is a computing device, such as the computer system/server 12 of FIG. 1. In embodiments, the prediction server 420 includes a prediction module 430, which comprises one or more program modules such as program modules 42 described with respect to FIG. 1. In embodiments, the prediction server 420 includes additional or fewer modules than those shown in FIG. 4. In embodiments, separate modules may be integrated into a single module. Additionally, or alternatively, a single module may be implemented as multiple modules. Moreover, the quantity of devices and/or networks in the environment is not limited to what is shown in FIG. 4. In practice, the environment may include additional devices and/or networks; fewer devices and/or networks; different devices and/or networks; or differently arranged devices and/or networks than illustrated in FIG. 4.

In embodiments, the optimization server 470 is a computing device, such as the computer system/server 12 of FIG. 1. In embodiments, the optimization server 470 includes an optimization module 480, which comprises one or more program modules such as program modules 42 described with respect to FIG. 1. In embodiments, the optimization server 470 includes additional or fewer modules than those shown in FIG. 4. In embodiments, separate modules may be integrated into a single module. Additionally, or alternatively, a single module may be implemented as multiple modules. Moreover, the quantity of devices and/or networks in the environment is not limited to what is shown in FIG. 4. In practice, the environment may include additional devices and/or networks; fewer devices and/or networks; different devices and/or networks; or differently arranged devices and/or networks than illustrated in FIG. 4.

In embodiments, the prediction server 420 and the optimization server 470 can be two separate servers or one single server (as shown by the dotted line at reference number 490).

In embodiments, a dynamic manufacturing environment 450 is a manufacturing environment which has at least one changeable state, i.e., is dynamic. In embodiments, a state of the dynamic manufacturing environment 450 includes a condition of the dynamic manufacturing environment 450. As an example, a state of the dynamic manufacturing environment 450 is an operating temperature which changes over time as the dynamic manufacturing environment 450 operates. As another example, a state is an amount of humidity in the dynamic manufacturing environment which changes over time. In contrast, a static manufacturing environment is a manufacturing environment where the state of the manufacturing environment does not change, i.e., is static. As an example, an operating temperature of a manufacturing environment remains constant over time as the manufacturing environment operates.

In embodiments, the dynamic manufacturing environment 450 includes various components 455. For example, the dynamic manufacturing environment 450 may comprise a cement grinding plant. In embodiments, examples of components 455 in the cement grinding plant include a separator component, a mill component, mill motor components, feed components, fan components, and a water injection component, amongst other components. In embodiments, each component of the components 455 includes at least one input as a setting. In embodiments, an input is controllable or uncontrollable. In further embodiments, if there are multiple inputs for a component of the components 455, the multiple inputs can be controllable and/or uncontrollable. In the example of the cement grinding plant, an example of a setting includes a separator speed setting for a separator component. As a further example of the separator speed setting, an example of an input is 10 revolutions per minute (rpm). In this example, the input of 10 rpm may be dynamic or may be static. In embodiments, the dynamic manufacturing environment 450 includes controllable inputs and uncontrollable inputs. An example of a controllable input is an amount of power input into a mill motor component of the cement grinding plant.

In embodiments, the components 455 in the dynamic manufacturing environment 450 produce an output of the dynamic manufacturing environment 450. As an example of an output, if the dynamic manufacturing environment 450 is a cement grinding plant, the components 455 of the cement grinding plant produce an output of ground cement. In this way, the output of the dynamic manufacturing environment 450 depends on the inputs into the components 455. As an example, the fineness of the ground cement changes based on the inputs into the components 455. As another example, a temperature of the ground cement changes based on the inputs into the components 455. In embodiments, conditions of the dynamic manufacturing environment 450 also change in response to the inputs. As an example, an electricity consumption by the dynamic manufacturing environment 450 changes based on the inputs into the components 455.

In embodiments, the prediction module 430 receives data from sensors 460 in the dynamic manufacturing environment 450. In embodiments, the sensors 460 are based on supervisory control and data acquisition (SCADA) architecture and/or data acquisition (DAQ) architecture. In embodiments, the sensors 460 collect data from the components 455. In embodiments, the data includes values for controllable inputs and/or uncontrollable inputs that are input into the components 455. As an example, the sensors 460 collect fan speed of fan components in the cement grinding plant. In embodiments, the prediction module 430 receives the data from the sensors 460 through the network 410. In embodiments, the data from the sensors includes controllable inputs, uncontrollable inputs, and system states.

In embodiments, the prediction module 430 inputs the data from the sensors 460 into deep learning networks. In embodiments, the deep learning networks are neural networks. In embodiments, neural networks are computer-based structures of neurons that map an input to an output. In embodiments, the prediction module 430 collects the data from the sensors 460 over time as historical data and uses this historical data to train the neural network.

In embodiments, the optimization module 480 inputs the prediction models from the prediction server 420 to form an optimization problem. In embodiments, an example mathematical representation of the optimization problem is Expression (Ex.) (1) as follows:

$${maximize}_{{s}_{t} , {u}_{t}} {\sum }_{t = 1}^{T} r ( {s}_{t} , {s}_{t - 1} , … , {s}_{t - l} , {u}_{t} , {u}_{t - 1} , … , {u}_{t - l} ) \\ subject to {s}_{t} = f ( {s}_{t - 1} , … , {s}_{t - l} , {u}_{t} , {u}_{t - 1} , … , {u}_{t - l} ) \\ {\underline{s}}_{t} \leq {s}_{t} \leq {\overline{s}}_{t} \\ {\underline{u}}_{t} \leq {u}_{t} \leq {\overline{u}}_{t} \qquad ( 1 )$$

In embodiments, t represents a timestep, with an uppercase T representing a time horizon. In embodiments, st represents a state of the dynamic manufacturing environment 450 over the timestep t. Further, uₜ represents a controllable input in the dynamic manufacturing environment 450 over the timestep t. In embodiments, r in the above Ex. (1) represents an output (reward) of the dynamic manufacturing environment 450 based on a time window length l of inputs, while ƒ represents a state transition function.

In embodiments, the optimization module 480 solves the optimization problem in Ex. (1) to determine the inputs for a desirable output.

In embodiments, a linearizable neural network is used to learn the output function r and the state transition function ƒ. Examples of linearizable neural network include recurrent neural network (RNN), long-short term memory (LSTM), and multi-layer perceptron (MLP).

In embodiments, the neural networks include a recurrent neural network (RNN) network. In this way, the deep learning network is a RNN network. In even further embodiments, the RNN is a long-short term memory (LSTM) network. In embodiments, the RNN network is a nonconvex neural network, i.e., a neural network which has a varying output with a non-linear nonconvex relationship with inputs. In embodiments, a RNN network is a neural network having weighted connections within a layer of neurons. In embodiments, a neuron is a mathematical function which receives an input and generates an output based on the input. In embodiments, the RNN network includes loops, which allows the RNN network to store information while processing new inputs using the neurons. In embodiments, as the prediction module 430 inputs data into the RNN network, the neurons output data. Over time, as a neuron outputs data, the connections to that neuron are given a weight matrix (W).

In embodiments, a RNN network carries an internal state (sₜ) of the dynamic manufacturing environment 450. In embodiments, the internal state (sₜ) indicates that the next state in the dynamic manufacturing environment 450 depends on the controllable input (uₜ) and also previous states and previous inputs. A mathematical example of this relationship is shown as Ex. (2) as follows:

sₜ=σₜ(Aₛsₜ₋₁+Bₛuₜ₋₁+Cₛuₜ+dₛ)

yᵢ=σᵣ(Aᵣsₜ₋₁+Bᵣuₜ₋₁+Cᵣuₜ+dᵣ) (2)

r(sₜ, . . . )=yₜ

In embodiments, for Ex. (2), σₜ and σᵣ represents an activation function, while sₜ represents the internal state of the dynamic manufacturing environment 450 at timestep t. In embodiments, the activation function is a linearizable function which activates neurons in the RNN network in a specific order. In embodiments, examples of the activation function include rectified linear unit (ReLU), leaky ReLU, and piecewise linear unit (PLU). In embodiments, Aₛ, Bₛ, Cₛ, dₛ, Aᵣ, Bᵣ, Cᵣ, dᵣ represent model parameters, i.e., weights for the connections between neurons in the RNN network. In embodiments, the model parameters are vectors dₛ, dᵣ and matrices Aₛ, Bₛ, Cₛ, Aᵣ, Bᵣ, Cᵣ. In further embodiments, the prediction module 430 generates the matrices and vectors using historical data from the sensors 460. In embodiments, (yₜ) represents an output of the dynamic manufacturing environment 450. In embodiments, an example of the output includes the reward value.

In embodiments, (sₜ) and (yₜ) are rewritable into compact form as Ex. (3) as follows:

hₜ=σ(W·[hₜ₋₁, Xₜ])

Using the above compact equation, the prediction module 430 solves the compact equation as W=[Aₛ, Bₛ, Cₛ, dₛ, Aᵣ, Bᵣ, Cᵣ, dᵣ], [hₜ₋₁,Xₜ]=[sₜ₋₁, uₜ₋₁, uₜ].

In embodiments, the optimization module 480 linearizes the L-RNN network by linearizing the piece-wise linear activation functions. In embodiments, the prediction module 430 linearizes a rectified linear unit (ReLU) activation function to the network if the deep learning network is an RNN network. Alternatively, if the deep learning network is a LSTM network, the optimization module 480 linearizes both ReLU and a piecewise linear function (PLU) activation function.

An exemplary mathematical representation of the ReLU activation function y=max {0, a^{T}x+b} is Ex. (4) as follows:

[symbol]

≤a^{T}x+b−Mz

[symbol]

≤M(1+z)

[symbol]

≥0

[symbol]

≤a^{T}x+b

zε{0,1}

In one example, Ex. (4) is for a sufficietnly large M, for example, M=10⁸.

In embodiments, y in Ex. (4) represents the output of a single neuron in the RNN network.

In embodiments, in response to the RNN network being a LSTM network, the optimization module 480 applies a PLU activation function to replace a tanh activation function to linearize the LSTM network. In embodiments, a PLU activation function is an approximation of a tanh function using a ReLU function. In embodiments, the LSTM network has a PLU activation function, as shown in Ex. (5) below:

PLU(x)=max(a(x+c)−c, min(a(x−c)+c, x))

for a constant c>0. In embodiments, the value for c can be trainable.

In embodiments, the optimization module 480 replaces the tanh activation with the PLU activation function h(x) to linearize the LSTM network. This is shown by Ex. (6) below:

h(x)=

[symbol]

[symbol]

≤α(x+c)−c

[symbol]

≤v

[symbol]

≤α(x+c)−c+M(1−z)

[symbol]

≤v+Mz

zε{ ),1}

v≤α(x−e)+e

v≤x

v≥α(x−c)+c−M(1−e)

e≤x−Me

eε{0,1}

In one example, Ex. (6) is for a sufficietnly large M, for example, M=10⁸. In this way, the optimization module 480 linearizes the network by replacing a rectified linear unit (ReLU) activation function with a set of equivalent linear equations shown in Ex. (4) in response to the neural network being an RNN network. Alternatively, in response to the RNN network being a LSTM network, the optimization module 480 linearizes the network by replacing a piecewise linear function (PLU) activation function with a set of equivalent linear equations shown in Ex. (6) to the network.

In embodiments, the PLU activation function for the LSTM network is also representable with further activation functions. For example, the LSTM network with PLU activation functions is representable as Ex. (7) as follows:

fₜ=σ_{g}(\hat{f}ₜ)

\hat{f}ₜ=W_{f}xₜ+U_{f}hₜ₋₁+b_{f}

iₜ=σ_{g}(îₜ)

îₜ=Wᵢxᵢ+Uᵢhₜ₋₁bᵢ

oₜ=σ_{g}(ôₜ)

ôₜ=Wₒxₜ+Uₒhₜ₋₁+bₒ

\tilde{c}ₜ=σ_{c}(ĉₜ)

ĉₜ=W_{c}xₜ+U_{c}hₜ₋₁+b_{c}

cₜ=uₜ+vₜ

u_{t,j}=f_{i,j}·c_{t-z,j}, j=1, . . . , h

v_{t,j}=i_{t,j}·\tilde{c}_{t,j}, j=1, . . . , h

[symbol]

ₜ=σₕ(cₜ)

h_{t,j}=o_{i,j}· [symbol] _{t,j}, j=1, . . . , h

In the above Ex. (7), (xₜ) are control variables, while (hₜ) are state variables. In embodiments, W, U, b, M: are model parameters, i.e., weights of neuron connections within the LSTM network. The remaining variables like it, ot, ft, ct are slack variables. σ_{g}, σ_{c}, σₕ are activation functions.

In embodiments, the above Ex. (7) is further linearizable by the optimization module 480 applying McCormick's envelope for every bilinear term of the form x·y to obtain the following Ex. (8):

$${f}_{t} = {σ}_{g} ( {\hat{f}}_{t} ) \\ {\hat{f}}_{t} = {W}_{f} {x}_{i} + {U}_{j} {h}_{i - 1} + {b}_{j} \\ {i}_{t} = {σ}_{g} ( {\hat{i}}_{t} ) \\ {\hat{i}}_{t} = {W}_{i} {x}_{i} + {U}_{i} {h}_{t - 1} + {b}_{i} \\ {o}_{t} = {σ}_{g} ( {\hat{o}}_{t} ) \\ {\hat{o}}_{t} = {W}_{o} {x}_{i} + {U}_{o} {h}_{t - 1} + {b}_{o} \\ {\tilde{c}}_{t} = {σ}_{c} ( {\hat{c}}_{t} ) \\ {\hat{c}}_{t} = {W}_{o} {x}_{t} + {U}_{c} {h}_{t - 1} + {b}_{c} \\ {c}_{t} = {u}_{i} + {v}_{i} \\ {u}_{i , j} \geq {M}_{f}^{L} {c}_{t - 1 , j} + {M}_{c}^{L} {f}_{i , j} - {M}_{f}^{L} {M}_{c}^{L} , j = 1 , … , h \\ {u}_{i , j} \geq {M}_{f}^{U} {c}_{t - 1 , j} + {M}_{c}^{U} {f}_{i , j} - {M}_{f}^{U} {M}_{c}^{U} , j = 1 , … , h \\ {u}_{i , j} \leq {M}_{f}^{U} {c}_{t - 1 , j} + {M}_{c}^{L} {f}_{i , j} - {M}_{f}^{U} {M}_{c}^{L} , j = 1 , … , h \\ {u}_{i , j} \leq {M}_{e}^{U} {f}_{t , j} + {M}_{f}^{L} {c}_{t - 1 , j} - {M}_{f}^{L} {M}_{c}^{U} , j = 1 , … , h \\ {v}_{t , j} \geq {M}_{i}^{L} {\tilde{c}}_{t , j} + \text{?} {i}_{t , j} - {M}_{i}^{L} \text{?} , j = 1 , … , h \\ {v}_{t , j} \geq {M}_{i}^{U} {\tilde{c}}_{t , j} + \text{?} {i}_{t , j} - {M}_{i}^{U} \text{?} , j = 1 , … , h \\ {v}_{t , j} \leq {M}_{i}^{U} {\tilde{c}}_{t , j} + \text{?} {i}_{t , j} - {M}_{i}^{U} \text{?} , j = 1 , … , h \\ {v}_{t , j} \leq \text{?} {i}_{t , j} + {M}_{i}^{L} {\tilde{c}}_{t , j} - {M}_{i}^{L} \text{?} , j = 1 , … , h \\ {y}_{t} = {σ}_{h} ( {c}_{t} ) \\ {h}_{i , j} \geq {M}_{o}^{L} \text{?} + {M}_{y}^{L} \text{?} - {M}_{o}^{L} {M}_{y}^{L} , j = 1 , … , h \\ {h}_{i , j} \geq {M}_{o}^{U} {y}_{t , j} + {M}_{y}^{U} \text{?} - {M}_{o}^{U} {M}_{y}^{U} , j = 1 , … , h \\ {h}_{t , j} \leq {M}_{o}^{U} {y}_{t , j} + {M}_{y}^{L} \text{?} - {M}_{o}^{U} {M}_{y}^{L} , j = 1 , … , h \\ {h}_{t , j} \leq {M}_{y}^{U} \text{?} + {M}_{o}^{L} \text{?} - {M}_{o}^{L} {M}_{y}^{U} , j = 1 , … , h \\ \text{?} \text{indicates text missing or illegible when filed}$$

In the above Ex. (8), (xₜ) are control variables, while (hₜ) are state variables. In embodiments, W, U, b, M: are model parameters, i.e., weights of neuron connections within the LSTM network. The remaining variables like iₜ, oₜ, fₜ, cₜ are slack variables.

In embodiments, the prediction module 430 learns correlations between inputs and outputs using the linearized network. In embodiments, the prediction module 430 learns the correlations by taking the data from the sensors 460 and inputting it into the RNN network whose output now has a linear relationship with inputs and is no longer nonconvex. In embodiments, the prediction module 430 learns over time which inputs correlates to which outputs as the prediction module 430 inputs the data from the sensors 460 into the RNN network and the prediction module 430 receives an output in response to the input.

In embodiments, the optimization module 480 prunes the RNN network so that relatively fewer neurons are present in the RNN network, thereby reducing consumption of computing resources and storage when storing the network. In embodiments, the optimization module 480 prunes the RNN network by removing redundant neurons and redundant connection weights to obtain a relatively smaller neural network, i.e., fewer neurons. In embodiments, the optimization module 480 determines the redundant neurons by comparing the information in a neuron to another neuron in the RNN network. In embodiments, if the neurons have the same information, i.e., a same input, and same weighted connections, the optimization module 480 determines that the neurons are redundant and removes one of the redundant neurons, along with the corresponding redundant connections. In embodiments, the optimization module 480 removes the redundant neuron by changing the value in the redundant neuron to zero and also changing the weights of the connections to the redundant neuron to zero. In embodiments, the optimization module 480 obtains new weights for the remaining neurons in the pruned network. As an example, the optimization module 480 obtains the new weights by solving the following Ex. (9) for each linear layer WX:

$${min}_{A , B} F ( A , B ) = \frac{1}{2} {‖ {[ WX - ( {A}^{T} A + B ) X ]}_{ℐ} ‖}^{2} + α {\sum }_{( i , j ) ∈ 𝒜} {y}_{i , j}^{2} \\ s . t . {[ ( {A}^{T} A + B ) X ]}_{i , j} \leq {y}_{i , j} , ∀ ( i , j ) ∈ 𝒜 \\ {y}_{i , j} \geq 0 , ∀ ( i , j ) ∈ 𝒜 \\ {‖ B ‖}_{0} \leq κ , \\ ℐ = \{ ( i , j ) {: [ WX ]}_{i , j} > 0 \} , 𝒜 = \{ ( i , j ) {: [ WX ]}_{i , j} \leq 0 \}$$

In embodiments, for Ex. (9), (y_{i,j}) is a placeholder variable, (κ) is a number of nonzero entries in a matrix (B), (A) and (I) are index sets, (W) represents weights of the connections, (X) represents variables at each linear layer of the RNN network, and α is a positive parameter. The weighted connection W is replaced by A^{T}A+B in the pruned network.

In embodiments, the optimization module 480 uses the pruned RNN network to predict the output from the inputs xₜ=(sₜ, uₜ) for the dynamic manufacturing environment 450. In embodiments, the optimization module 480 receives a desired output value from an administrator in the dynamic manufacturing environment 450. As an example, the desired output value is specific ground cement fineness value, along with a goal of minimizing electricity consumption while outputting the specific ground cement fineness value. In embodiments, the optimization module 480 receives the desired output value through the network 410.

In embodiments, with the desired output value set, the optimization module 480 generates the predicted inputs (xₜ) by optimizing for the pruned network. In embodiments, optimizing for the pruned network results in finding a state (sₜ) of the dynamic manufacturing environment 450, with the state (sₜ) serving as a boundary for the function (ƒ), i.e., the desired output. Solving for the state (sₜ) allows for generation of the predicted inputs (xₜ) by plugging the state (sₜ) values and the controllable input (uₜ) input values into using the transition function (ƒ). In this way, the optimization module 480 generates the predicted inputs (xₜ) for the dynamic manufacturing environment 450 using the linearized network.

In embodiments, the optimization module 480 uses the predicted inputs (xₜ) in the dynamic manufacturing environment 450. In embodiments, the optimization module 480 uses the predicted inputs (xₜ) by sending the predicted inputs (xₜ) to the administrator in the dynamic manufacturing environment 450 through the network 410. In embodiments, the administrator enters the predicted inputs (x_{τ}) into the components 455 to achieve the desired output value. For example, the predicted inputs (x_{τ}) are for a separator component to run at 20 revolutions per minute (rpm) to achieve a desired output value of 3,000 to 5,000 cm²/g for Blaine fineness. In alternative embodiments, the optimization module 480 uses the predicted inputs (xₜ) by entering the predicted inputs (xₜ) directly into the components 455 by accessing the components through the network 410. In this way, using the predicted inputs (xₜ) includes the optimization module 480 inputting the predicted inputs (xₜ) into the components 455 of the dynamic manufacturing environment 450.

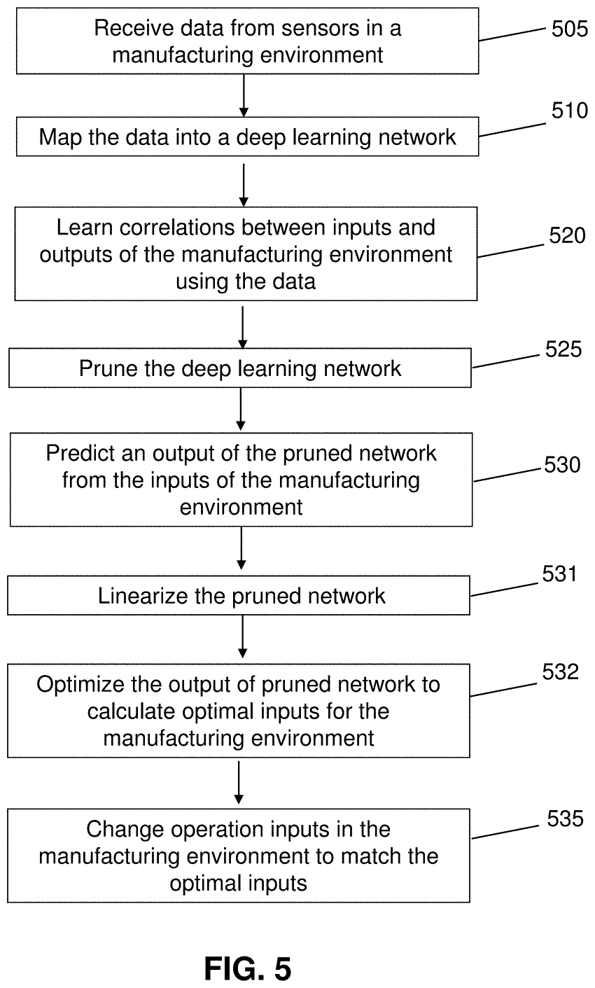

FIG. 5 shows a flowchart of an exemplary method in accordance with aspects of the present invention. Steps of the method may be carried out in the environment of FIG. 4 and are described with reference to elements depicted in FIG. 4.

At step 505, the system receives data from sensors in a manufacturing environment . In embodiments, and as described with respect to FIG. 4, the prediction module 430 receives data from sensors 460 through the network 410.

At step 510, the system maps the data into a deep learning network. In embodiments, and as described with respect to FIG. 4, the prediction module 430 inputs the data from the sensors 460 into a RNN network.

At step 520, the system learns correlations between inputs and outputs of the manufacturing environment using the data. In embodiments, and as described with respect to FIG. 4, the prediction module 430 learns the correlations by inputting the data from the sensors 460 into the RNN network shown in Ex. (2) and receiving an output from the RNN network. In embodiments, over time, the prediction module 430 learns which inputs correlate to which outputs.

At step 525, the system prunes the deep learning network. In embodiments, and as described with respect to FIG. 4, the prediction module 430 prunes the RNN network by removing redundant neurons and redundant connection weights to obtain a relatively smaller neural network, i.e., fewer neurons and fewer non-zero weights. In embodiments, the optimization module 480 removes the redundant neurons and weights by comparing the information in a neuron to another neuron in the RNN network. In response to the neurons having the same information, the optimization module 480 determines that the neurons are redundant. In response to determining there are redundant neurons, the optimization module 480 removes at least one of the redundant neurons and its corresponding connections. In embodiments, the optimization module 480 removes the redundant neuron by changing the value in the redundant neuron to zero and also changing the weights of the connections of the redundant neuron to zero.

At step 530, the system predicts an output of the pruned network from the inputs of the manufacturing environment. In embodiments, and as described with respect to FIG. 4, the prediction module 430 receives the inputs from an administrator in the dynamic manufacturing environment 450.

At step 531, the system linearizes the deep neural network. In embodiments, and as described with respect to FIG. 4, the optimization module 480 linearizes the network by replacing a rectified linear unit (ReLU) activation function by a set of equivalent linear equations shown in Ex. (4) in response to the neural network being an RNN network. Alternatively, in response to the RNN network being a LSTM network, the optimization module 480 linearizes the network by replacing a piecewise linear function (PLU) activation function by a set of equivalent linear equations shown in Ex. (6) to the network.

At step 532, the system optimizes the output of the pruned deep neural network to calculate predicted inputs for the manufacturing environment. In embodiments, with a desired output value from an administrator, the optimization module 480 optimizes the output of pruned network by a mixed-integer linear programing to calculate the predicted inputs (xₜ).

At step 535, the system changes the operation inputs in the manufacturing environment to match the predicted inputs. In embodiments, and as described with respect to FIG. 4, the optimization module 480 uses the predicted inputs (xₜ) by sending the predicted inputs (xₜ) to an administrator in the dynamic manufacturing environment 450 through the network 410. In alternative embodiments, the optimization module 480 uses the predicted inputs (xₜ) by entering the predicted inputs (xₜ) directly into the components 455 by accessing the components through the network 410.

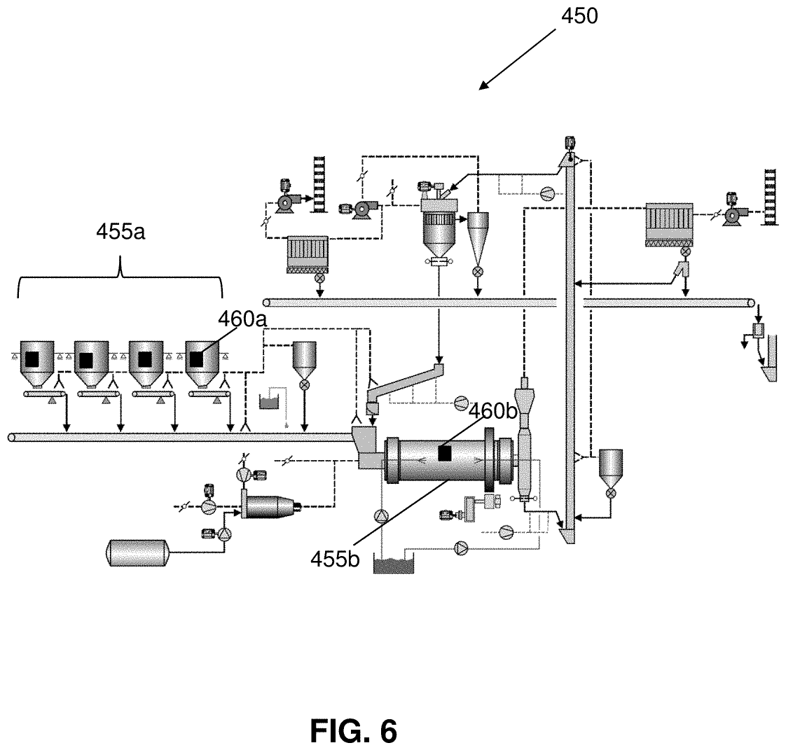

FIG. 6 shows an exemplary use in accordance with aspects of the present invention and is described with reference to elements depicted in FIG. 4. In embodiments, FIG. 6 illustrates a cement grinding plant as the dynamic manufacturing environment 450. In embodiments, the prediction module 430 receives data from the sensors 460a for the components 455a, and receives data from the sensors 460b for the components 455b. In embodiments, the components 455a are feed components, while the component 455b is a ball mill. In embodiments, the prediction module 430 receives data from sensors within the cement grinding plant, e.g., sensors 460a, 460b. In embodiments, the prediction module 430 inputs the data into a deep learning network and linearizes the data to determine correlations between inputs and outputs in the cement grinding plant. In embodiments, the prediction module 430 prunes the deep learning network and uses the pruned deep learning network to predict inputs (xₜ) for the cement grinding plant. In embodiments, the prediction module 430 then uses the predicted inputs (xₜ) by sending the predicted inputs (xₜ) to an administrator in the dynamic manufacturing environment 450 or by entering the predicted inputs (xₜ) directly into at least one of the components 455a, 455b. As an example, the prediction module changes a speed of the components 455a to match the predicted inputs (xₜ) for the components 455a. In this way, the prediction module 430 uses the predicted inputs (xₜ) by changing operation inputs of the components 455a of the dynamic manufacturing environment 450 to match the predicted inputs (xₜ).

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system/server 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
receiving, by a computing device, data from sensors in a manufacturing environment;
mapping, by the computing device, the data into a deep learning network;
learning, by the computing device, correlations between inputs and outputs of the manufacturing environment using the data;
pruning, by the computing device, the deep learning network;
predicting, by the computing device and using the pruned network, an output of the pruned network from the inputs of the manufacturing environment;
linearizing, by the computing device, the pruned network;
optimizing, by the computing device, the output of the linearized pruned network to calculate predicted inputs for the manufacturing environment; and
changing, by the computing device, operation inputs in the manufacturing environment to match the predicted inputs.

2. The method of claim 1, wherein the sensors are based on supervisory control and data acquisition (SCADA) architecture.

3. The method of claim 1, wherein the sensors are based on data acquisition (DAQ) architecture.

4. The method of claim 1, wherein the deep learning network is a recurrent neural network (RNN) network.

5. The method of claim 4, wherein the RNN network is a long-short term memory (LSTM) network.

6. The method of claim 1, further comprising linearizing the deep learning network by replacing a rectified linear unit (ReLU) activation function with a set of equivalent linear equations to the deep learning network in response to the deep learning network being a RNN network.

7. The method of claim 1, further comprising:
linearizing the deep learning network by replacing a tanh activation function with a piecewise linear function (PLU) activation function; and
reformulating the PLU activation function into a set of equivalent linear equations to the deep learning network in response to the deep learning network being a LSTM network.

8. The method of claim 1, further comprising linearizing the deep learning network by replacing a bilinear term in the deep learning network by the McCormick envelope.

9. The method of claim 1, wherein the pruning the deep learning network includes removing redundant neurons in the deep learning network.

10. The method of claim 9, wherein the pruning the deep learning network includes removing redundant connections of the redundant neurons.

11. The method of claim 1, wherein the manufacturing environment is a dynamic manufacturing environment.

12. The method of claim 1, wherein the computing device includes software provided as a service in a cloud environment.

13. A computer program product comprising one or more computer readable storage media having program instructions collectively stored on the one or more computer readable storage media, the program instructions executable to:
receive data from sensors in a manufacturing environment;
map the data into a deep learning network;
learn correlations between inputs and outputs of the manufacturing environment using the data;
prune the deep learning network;
predict inputs for the manufacturing environment using the pruned deep learning network;
linearize the pruned deep learning network;
optimize a predicted output from the linearized pruned deep learning network to calculate predicted inputs for the manufacturing environment; and
change operation inputs in the dynamic manufacturing environment to match the predicted inputs.

14. The computer program product of claim 13, wherein the deep learning network is a recurrent neural network (RNN) network.

15. The computer program product of claim 14, wherein the RNN network is a long-short term memory (LSTM) network.

16. The computer program product of claim 13, wherein the sensors are based on supervisory control and data acquisition (SCADA) architecture.

17. A system comprising:
a processor, a computer readable memory, one or more computer readable storage media, and program instructions collectively stored on the one or more computer readable storage media, the program instructions executable to:
receive data from sensors in a dynamic manufacturing environment;
map the data into a recurrent neural network (RNN) network;
learn correlations between inputs and outputs of the dynamic manufacturing environment using the RNN network;
prune the RNN network;
predict inputs for the dynamic manufacturing environment using the pruned RNN network;
linearize the pruned RNN network;
optimize a predicted output from the linearized pruned RNN network to calculate predicted inputs; and
change operation inputs in the dynamic manufacturing environment to match the predicted inputs.

18. The system of claim 17, wherein the RNN network is a long-short term memory (LSTM) network.

19. The system of claim 17, wherein the pruning the RNN network includes removing redundant neurons and connections in the RNN network.

20. The system of claim 17, wherein the changing the operation inputs includes inputting the predicted inputs into components of the dynamic manufacturing environment.
